(19) United States
(12) Patent Application Publication
(10) Pub. No.: US 2008/0159649 A1
(43) Pub. Date: Jul. 3, 2008

(54) DIRECTIONAL FIR FILTERING FOR IMAGE ARTIFACTS REDUCTION

(75) Inventors: Jeffrey Matthew Kempf, Dallas, TX (US); David Foster Lieb, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/617,885

(22) Filed: Dec. 29, 2006

(51) Int. Cl. G06K 9/40

(52) U.S. Cl. 382/275; 382/266

(57) ABSTRACT

The image processing method and system improve the digital image quality by filtering the image along edges of image features while maintaining feature details.

### TECHNICAL FIELD

The technical field of the examples to be disclosed in the following sections relates to the art of image processing and more particularly to the art of methods and apparatus for improving digital image qualities.

### BACKGROUND

Digital image and video compression are essential in this information era. Internet teleconferencing, High Definition Television (HDTV), satellite communications and digital storage of movies would not be feasible without compression. This arises from the fact that transmission mediums have limited bandwidth; and the amount of data generated by converting images from analog to digital form is so great that digital data transmission would be impractical if the data could not be compressed to require less bandwidth and data storage capacity.

For example, bit rates and communication protocols in conventional digital television are determined entirely by system hardware, such as image size, resolution and scanning rates. Images are formed by “pixels” in ordered rows and columns where each pixel must be constantly re-scanned and re-transmitted. Television quality video requires approximately 100 GBytes for each hour; or about 27 Mega bytes for each second. Such data sizes and rates severely stress storage systems and networks and make even the most trivial real-time processing impossible without special purpose hardware. Consequently, most video data is stored in a compressed format.

According to the CCIR-601 industry standard digital television comparable to analog NTSC television would contain 720 columns by 486 lines. Each pixel is represented by 2 bytes (5 bits per color=32 brightness shades) which are scanned at 29.97 frames per second. That requires a bit rate of about 168 Mb/s or about 21 Mega bytes per second. A normal CD-ROM can store only about 30 seconds of such television. The bit rate will not be affected no matter what images are shown on the screen. As a result, a number of video compression techniques have been proposed.

While video compression reduces the transmission and storage cost, it introduces multiple types of artifacts. For example, most current video compression techniques, including the widely used MPEG (Moving Picture Experts Group) standards, introduce noticeable image artifacts when compressing at bit rates typical to cable (e.g. around 57 Mbps) and satellite TV distribution channels (e.g. 17 Mbps). The two most noticeable and disturbing artifacts are blocking artifacts (also called quilting and checker boarding) and mosquito noises (e.g. noise patterns near sharp scene edges).

Blocking artifacts present as noticeable distracting blocks in produced images. This type of artifact results from independent encoding (compressing) of each block with reduced precision, which in turn, causes adjacent blocks not matching in brightness or color. Mosquito noise appears as speckles of noise near edges in the produced image. This type of noise results from high frequency components of sharp edges being discarded and represented with lower frequencies.

### SUMMARY

In an example, a method for processing an image having an array of image pixels is disclosed herein. The method comprises: defining a plurality of image pixel sub-arrays; and processing an image pixel a sub-array, comprising: calculating a plurality of directional variances for image pixels; determining an array of coefficients of a filter based on the calculated directional variances; and filtering the image pixel with the filter.

In another example, a method for improving quality of an image is disclosed herein. The method comprises: detecting an edge and an edge direction of an image feature; and filtering the image along the detected edge direction so as to improve a quality of the image.

In yet another example, a device for reducing a compression artifact in a block compressed image is disclosed herein. The device comprises: a block boundary identification module for identifying an edge of an image feature in the image; a directional correction measurement module for identifying a direction of the identified edge of the image feature; and a filter coupled to the block boundary identification and directional correlation modules for filtering the input image, wherein the filter comprises a set of filtering coefficients that are determined by the identified image edge and image edge direction.

In yet another example, a computer-readable medium having computer executable instructions for performing a method for processing an image having an array of image pixels is disclosed, wherein the method comprises: defining a plurality of image pixel sub-arrays; and processing an image pixel a sub-array, comprising: calculating a plurality of directional variances for image pixels; determining an array of coefficients of a filter based on the calculated directional variances; and filtering the image pixel with the filter.

In yet another example, a system for processing an image having an array of image pixels is disclosed. The system comprising: first means for defining a plurality of image pixel sub-arrays; and second means associated with the first means for processing an image pixel a sub-array, comprising: third means for calculating a plurality of directional variances for image pixels; fourth means coupled to the third means for determining an array of coefficients of a filter based on the calculated directional variances; and fifth mean coupled to the third and fourth means for filtering the image pixel with the filter.

In yet another example, a computer-readable medium having computer executable instructions for performing a method for improving quality of an image is disclosed herein, wherein the method comprises: detecting an edge and an edge direction of an image feature; and filtering the image along the detected edge direction so as to improve a quality of the image.

In yet another example, a system for improving quality of an image is disclosed herein. The method comprises: detecting means for detecting an edge and an edge direction of an image feature; and filtering means for filtering the image along the detected edge direction so as to improve a quality of the image.

### BRIEF DESCRIPTION OF DRAWINGS

FIG. 1 is a diagram demonstrating an artifact reduction algorithm;

FIG. 2 is a flow chart showing the steps executed in performing the artifact reduction method;

FIG. 3a presents 4 adjacent blocks in a compressed image using a block compressing technique;

FIG. 3b shows the boundaries of the 4 adjacent blocks in FIG. 3a;

FIG. 4 presents a 7 by 7 matrix used for identifying block boundaries of FIG. 3a;

FIG. 5 presents the enlarged image of FIG. 3a aligned with the enlarged matrix in FIG. 4 during the boundary identification process;

FIG. 6 presents the identified boundaries from the method of FIG. 5;

FIG. 7 is a diagram demonstrating a method for detecting edge directions;

FIG. 8 is a diagram showing an exemplary electronic circuit in which an exemplary artifact reduction method is implemented; and

FIG. 9 schematically illustrates an exemplary display system employing an exemplary artifact reduction method.

### DETAILED DESCRIPTION OF EXAMPLES

Disclosed herein comprises a method and a system for improving digital image qualities by reducing or eliminating image artifacts, such as compression artifacts, using a directional variance filter such that the filtering is performed substantially along edges of image features. The filtering can be performed using many suitable filtering techniques, one of which is a low pass FIR (Finite Impulse Response). Image sharpening can also be included.

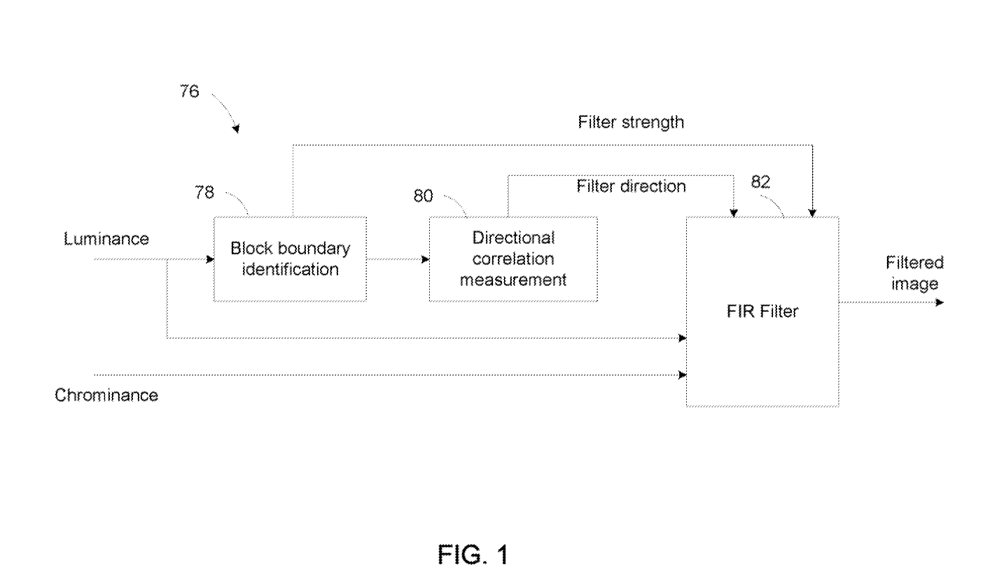

Referring to the drawings, FIG. 1 the algorithm for reducing image compression artifacts is illustrated therein. The algorithm employs filter 82 for reducing artifacts in digital images. The filter can employ various image processing techniques, such as smoothing. In an example, the filter comprises a Finite Impulse Response filter. The FIR filter involves a FIR transformation function f(k,l). The FIR filtering process can be presented as the convolution of the two dimensional image signal x(m,n) with the impulse function f(k,l), resulting in output of two dimensional processed image y(m,n). The basic equation of the FIR process is shown in equation 1:

$$y ( m , n ) = f ( k , l ) ⊗ x ( m . n ) \\ y ( m , n ) = {\sum }_{k = - N}^{N} {\sum }_{l = - N}^{N} f ( k , l ) x ( m - k , n - l ) \qquad ( Eq . 1 )$$

wherein f(k,l) function refers to the matrix of FIR filter coefficients. N is the number of filter taps. FIR filter coefficients f(k,l) comprise both filter strength and filter direction components such that when applied to an input image, artificial effect reductions, such as smoothing with the low pass filter of the FIR filter, can be performed along, and more preferably, only along the edges of image features, which will be detailed afterwards.

The filter strength is obtained by boundary identification module 78. Specifically, the boundary identification module finds edges of image features, along the edges which the following smoothing operation can be performed. The boundary identification module can also collect information on strength distribution of local blocking artifacts. Such local artifact strength information can then be used to construct the FIR filter—as the strength of the FIR filter can be proportional to the strength of blocking artifacts present at image locations.

The FIR filter direction component is obtained by directional correlation measurement module 80. Specifically, the directional correlation measurement module is designated to identify the direction of edges in image features. It is noted that artifacts may also have edges; and such artifact edges are desired to be ignored. The obtained edge direction component is forwarded to the FIR filter to construct the filter transfer function f(k,l). In particular, each obtained edge direction contributes to the low pass FIR filter coefficients with a weighting determined by the directional correlation.

In an example, both calculations of block boundaries for filter strength and direction correlation for filter directions are based on the luminance component of the input image. However, the FIR filter is applied to both luminance and chrominance components of the input image; and the FIR filter outputs both luminance and chrominance components of the processed image. In other alternative examples, either or both calculation and filtering can be performed on both luminance and chrominance components, and other components of input images.

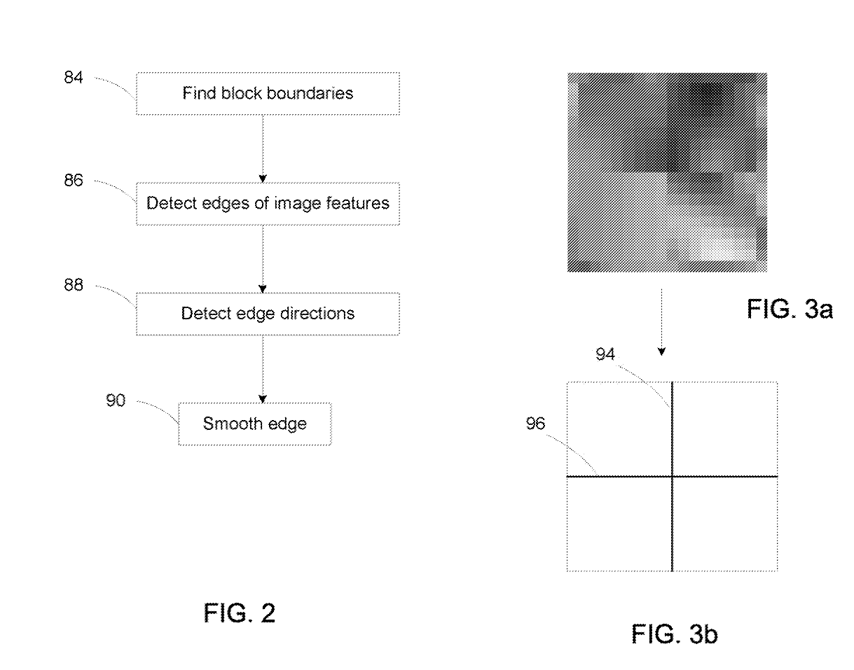

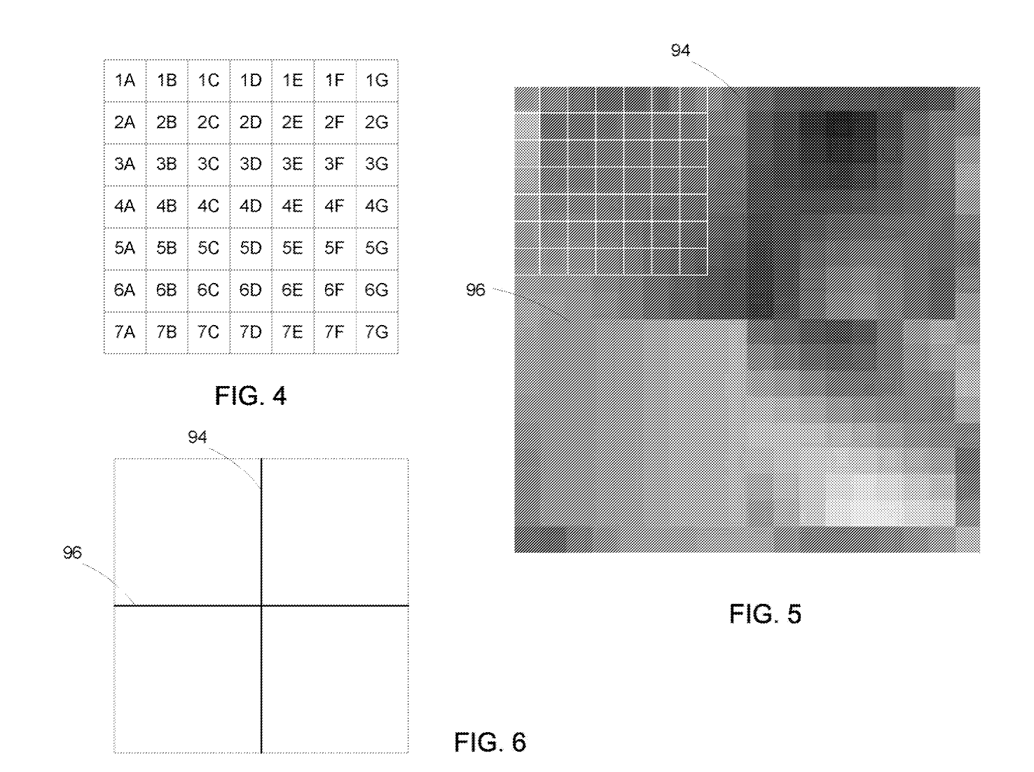

An exemplary method for identifying edges of image features of the input image that was compressed with a blocking compressing technique is illustrated in a flow chart in FIG. 2. The edge identification process starts from finding block boundaries in the input compressed image (step 84), for example, finding boundaries of blocks in FIG. 3a with the identified boundaries (e.g. boundaries 94 and 96) being illustrated in FIG. 3b. For this purpose, a detection window is defined. As an example, a detection window of 7×7 pixels, as shown in FIG. 4, is constructed. Such detection window is disposed on the target image and moved across the image, as shown in FIG. 5. In an example, the detection window is moved on the image such that the distance between two consecutive positions of the detection window is less than the size (e.g. the length or height or diagonal) of the detection window. As a result, the detection window at the next position has an overlap with the detection window at the immediate previous position. The overlap can be one column or more, one row or more, or one pixel (e.g. pixel 1A) or more. The block boundaries of the input image are detected within the detection window at each position based on the average gradients, individual gradients, and a set of predetermined criteria.

In an example, the average gradients are calculated along horizontal (row) and vertical (column) directions within each detection window at each position. In the example as shown in FIG. 4, the average vertical luminance gradient Gₐᵥₑ^{vertical} (i) of pixel in row i of the detection window can be calculated as:

$${G}_{ave}^{vertical} ( i ) = {\sum }_{i , j = 1}^{7} [ L ( i , j ) - L ( i + 1 , j ) ] / 7 \qquad ( Eq . 1 )$$

wherein L(i, j) is the luminance of pixel (i, j) in the detection window. For example, the average vertical luminance gradient of the pixels in the first row of the detect window can be calculated as: [(1A−2A)+(1B−2B)+(1C−2C)+(1D−2D)+(1E−2E)+(1F−2F)+(1G−2G)]/7.

The average vertical luminance gradient of the pixels in the second row of the detect window can be calculated as: [(2A−3A)+(2B−3B)+(2C−3C)+(2D−3D)+(2E−3E)+(2F−3F)+(2G−3G)]/7. This calculation is repeated for all seven rows.

In the example as shown in FIG. 4, the average horizontal luminance gradient Gₐᵥₑ^{horizontal}(j) of pixel in column j of the detection window can be calculated as:

$${G}_{ave}^{horizontal} ( j ) = {\sum }_{i , j = 1}^{7} [ L ( i , j ) - L ( i , j + 1 ) ] / 7 \qquad ( Eq . 2 )$$

wherein L(ij) is the luminance of pixel (ij) in the detection window. For example, the average horizontal luminance gradient of the pixels in the first column of the detect window can be calculated as: [(1A−1B)+(2A−2B)+(3A−3B)+(4A−4B)+(5A−5B)+(6A−6B)+(7A−7B]/7. The average horizontal luminance gradient of the pixels in the second column of the detect window can be calculated as: [(1B−1C)+(2B−2C)+(3B-3C)+(4B−4C)+(5B−5C)+(6B−6C)+(7B−7C]/7. This calculation is repeated for all seven columns.

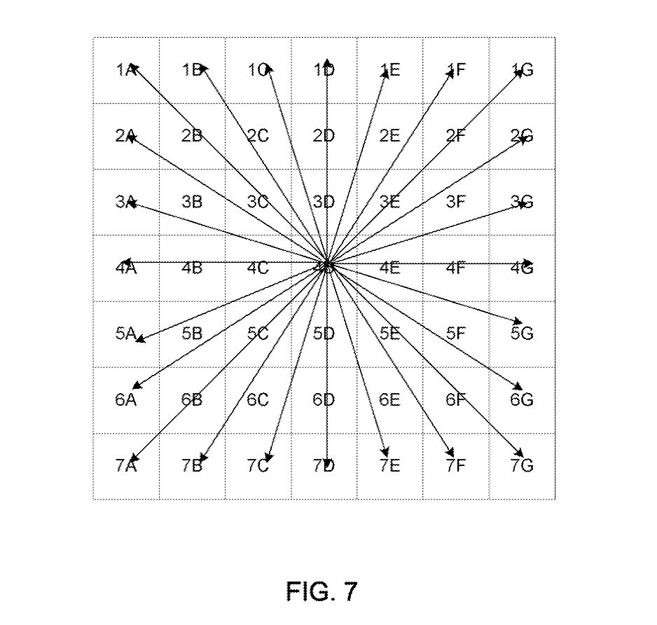

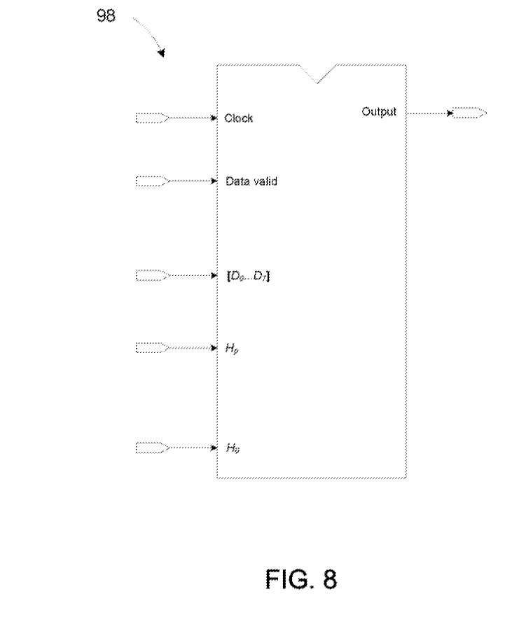

To identify the block boundaries, the maximum horizontal and vertical gradients within the detection window are determined, along with the application of the following criteria. In the block boundary, multiple maximum individual gradient locations matches (coincident with) the maximum average gradient locations. This criterion ensures a straight block boundary in presence. The gradient polarity (the + and − sign) along maximum gradients varies slowly. In the block boundary, there exist strong gradients above and below the maximum gradient in perpendicular directions. This criterion ensures ignorance of image feature corners. With the above calculated average and individual gradients in combination with the criteria, a block visibility measure is assembled based on the alignment of the calculated individual gradients and maximum gradients. The identified block boundaries of the block image as shown in FIG. 5 are illustrated as boundaries 94 and 96 in FIG. 6. As a summary, step 84 of flow chart in FIG. 2 obtains at least the following information: block boundaries, average and individual luminance gradients along vertical and horizontal directions, as well as the maximum values. This group of information is used to determine the filter strength of FIR filter (82 in FIG. 1). Specifically, this group of information is used to control the strength of the filtering, for example, filtering strongly in presence of artifacts; while filtering less or nothing in textured regions (e.g. image feature regions). As a way of example, if a 7×7 detection window has the image data as such:

| | | | | | | |
|---|---|---|---|---|---|---|
| 101 | 92 | 90 | 90 | 96 | 107 | 122 |
| 96 | 90 | 90 | 94 | 103 | 118 | 136 |
| 92 | 90 | 91 | 96 | 106 | 124 | 143 |
| 95 | 89 | 85 | 108 | 125 | 149 | 171 |
| 98 | 90 | 83 | 108 | 122 | 145 | 168 |
| 96 | 88 | 82 | 107 | 118 | 143 | 166 |
| 93 | 86 | 81 | 104 | 115 | 139 | 164 |

a block boundary can be detected as the 4^{th} column and 4^{th} row.

As discussed with reference to FIG. 1, the FIR filter also incorporates the direction of the edges of the image features. The edge and direction of the edges of image features are detected and calculated at steps 86 and 88 in the flow chart of FIG. 2 by directional correlation measurement module 80 in FIG. 1. An exemplary edge and edge direction detection are demonstrated in FIG. 7. It is noted that the edge and edge direction detection are desired to exclude edges introduced by compression. Referring to FIG. 7, the edge and edge direction are calculated from luminance variances of pixels in the overlapped detection windows. Luminance variance σ is calculated using equation 4 along radial directions as represented by arrows in FIG. 7.

σ=Σ[L(i,j)−μ]²/(N−1) (Eq 4)

wherein μ is the average luminance; and N is number of pixel values being calculated. The directional variance is a one dimensional variance calculation along a particular gradient. In the example as shown in FIG. 7, any suitable number of directional variances, such as 4, 8, 12, and 24, can be calculated. For example, if variances are calculated along 4 directions (0°, 45°, 90°, and 135°), the mean and variances can be calculated as follows for the detection window with the image data as:

| | | | | | | |
|---|---|---|---|---|---|---|
| 101 | 92 | 90 | 90 | 96 | 107 | 122 |
| 96 | 90 | 90 | 94 | 103 | 118 | 136 |
| 92 | 90 | 91 | 96 | 106 | 124 | 143 |
| 95 | 89 | 85 | 108 | 125 | 149 | 171 |
| 98 | 90 | 83 | 108 | 122 | 145 | 168 |
| 96 | 88 | 82 | 107 | 118 | 143 | 166 |
| 93 | 86 | 81 | 104 | 115 | 139 | 164 |

0° mean left of block boundary=(95+89+85)/3=89.7

0° mean right of block boundary=(108+125+149+171)/4=138.25

45° mean left of block boundary=(93+88+83)/3=88

45° mean right of block boundary=(108+106+118+122)/4=113.5

90° mean above block boundary=(90+91+96)/3=92.3

90° mean below block boundary=(108+108+107+104)/4=106.75

135° mean above block boundary=(101+90+91)/3=94

135° mean below block boundary=(108+122+143+164)/4=134.25

0° variance=(((95−89.7)²+(89−89.7)²+(85−89.7)²)/2+((108−138.25)²+(125−138.25)²+(149−138.25)²+(171−138.25)²)/3)/2=392.4592

45° variance=(((93−88)²+(88−88)²+(83−88)²)/2+((108−113.5)²+(106−113.5)²+(118−113.5)²+(122−113.5)²)/3)/2=42.3333

90° variance=(((90−92.3)²+(91−92.3)²+(96−92.3)²)/2+((108−106.75)²+(108−106.75)²+(107−106.75)²+(104−106.75)²)/3)/2=6.9592

135° variance=(((101−94)²+(90−94)²+(91−94)²)/2+((108−134.25)²+(122−134.25)²+(143−134.25)²+(164−134.25)²)/3)/2=318.6250

In another example, variances can be calculated along 12 different directions for the detection window as shown below:

1) Average mean μ along positive 0° degree direction:

$${\sum }_{j = 1}^{+ {B}_{+ 0}} L ( i , j ) / {B}_{+ 0} ;$$

2) Average mean μ along negative 0° degree direction:

$${\sum }_{j = 1}^{- {B}_{- 0}} L ( i , j ) / {B}_{- 0} ;$$

3) Average mean μ along positive 18.40 degrees direction:

[L(i,j)+L(i,j+1)+L(i−1, j+2)+L(i−1, j+3)]/4;

4) Average mean μ along negative 18.4° degrees direction:

[L(i,j)+L(i,j−1)+L(i+1, j−2)+L(i+1, j−3)]/4;

5) Average mean μ along positive 33.7° degrees direction:

[L(i,j)+L(i−2, j+3)+L(i−1, j+2)+L(i−1, j+1)]/4;

6) Average mean μ along negative 33.7° degrees direction:

[L(i,j)+L(i+1, j−1)+L(i+1, j−2)+L(i+2, j−3)]/4

7) Average mean μ along positive 45° degrees direction:

$${\sum }_{i = j = 1}^{+ {B}_{+ 45}} L ( i , j ) / {B}_{+ 45} ;$$

8) Average mean μ along negative 45° degrees direction:

$${\sum }_{i = j = 1}^{- {B}_{- 45}} L ( i , j ) / {B}_{- 45} ;$$

9) Average mean μ along positive 56.3° degrees direction:

[L(i−3, j+2)+L(i−2, j+1)+L(i−1, j+1)+L(i,j)]/4;

10) Average mean μ along negative 56.3° degrees direction:

[L(i,j)+L(i+1, j−1)+L(i+2, j−1)+L(i+3, j−2)]/4;

11) Average mean μ along positive 71.6° degrees direction:

[L(i−3, j+1)+L(i−2, j+1)+L(i−1, j)+L(i,j)]/4;

12) Average mean μ along negative 71.6° degrees direction:

[L(i,j)+L(i+1, j)+L(i+2, j−1)+L(i+3, j−1)]/4;

13) Average mean μ along positive 90° degrees direction:

$${\sum }_{i = 1}^{{B}_{+ 90}} L ( i , j ) / {B}_{+ 90} ;$$

14) Average mean μ along negative 90° degrees direction:

$${\sum }_{i = 1}^{- {B}_{- 90}} L ( i , j ) / {B}_{- 90} ;$$

15) Average mean μ along positive 108.4° degrees direction:

[L(i−3, j−1)+L(i−2, j−1)+L(i−1, j)+L(i,j)]/4;

16) Average mean μ along negative 108.4° degrees direction:

[L(i,j)+L(i+1, j)+L(i+2, j+1)+L(i+3, j+1)]/4;

17) Average mean μ along positive 123.7° degrees direction:

[L(i−3, j−2)+L(i−2, j−1)+L(i−1, j−1)+L(i,j)]/4;

18) Average mean μ along negative positive 123.7° degrees direction:

[L(i,j)+L(i+1, j+1)+L(i+2, j+1)+L(i+3, j+2)]/4;

19) Average mean μ along positive 135° degrees direction:

$${\sum }_{i = j = 1}^{{B}_{+ 135}} L ( i , j ) / {B}_{+ 135} ;$$

20) Average mean μ along negative 135° degrees direction:

$${\sum }_{i = j = 1}^{- {B}_{- 135}} L ( i , j ) / {B}_{- 135} ;$$

21) Average mean μ along positive 153.4° degrees direction:

[L(i−2, j−3)+L(i−1, j−2)+L(i−1, j−1 )+L(i,j)]/4;

22) Average mean μ along negative 153.4° degrees direction:

[L(i,j)+L(i+1, j+1)+L(i+1, j+2)+L(i+2, j+3)]/4

23) Average mean μ along positive 161.6° degrees direction:

[L(i−1, j−3)+L(i−1, j−2)+L(i, j−1)+L(i,j)]/4;

24) Average mean μ along negative 161.6° degrees direction:

[L(i,j)+L(i,j+1)+L(i+1, j+2)+L(i+1, j+3)]/4;

In the above equations, B₊₀, B₋₀, B₊₄₅, B₋₄₅, B₊₉₀, B₋₉₀, B₊₁₃₅, and B₋₁₃₅ are total number values for pixels before hitting a detected boundary along positive and negative 0°, 45°, 90°, and 135° directions, respectively. Along each twelve (12) direction, a variance σ² can be calculated using equation 4 along directions across the entire detection window. As an aspect of the example, variance calculations exclude block boundaries. Specifically, pixels in each variance calculation are located on the same side of a detected boundary—and no variance calculation is performed on pixels across a detected boundary. Pixels on different sides of a detected block boundary are used to calculate for different variances.

In the above examples, means are calculated along positive and negative directions from a center of the detection window. This is one of many possible examples. Other calculation methods for mean and variances can also be employed. For example, mean and variances all can be calculated across the entire detection window.

Given the calculated means along each direction, edges of image features can be detected according to the predetermined detection rules, for example, variance is low along image edges; while the variance is high across edges of image features. As an alternative feature, the calculated directional correlations (i.e. variances) can be spatially smoothed so as to minimize possible erroneous measurements. The spatial smooth can be performed by a standard data smoothing technique. The obtained edge and edge direction information are then delivered to the FIR filter to construct the transformation function of the FIR filter.

Given the block boundary information and directional correlation information extracted from luminance component respectively from block boundary module 78 and directional correlation module 80 in FIG. 1, a N×N (e.g. 7×7) FIR filter kernel is assembled. Specifically, each obtained edge and edge directional information contribute low-pass filter coefficients with a weighting determined by the directional correlation. Specifically, image pixels with low directional variance receive high coefficients; and conversely, image pixels with high directional variance receive low coefficients. In an example, a Gaussian transfer function is used to smoothly control weighting. In the above example wherein a 7×7 detection window is employed with the data as:

| | | | | | | |
|---|---|---|---|---|---|---|
| 101 | 92 | 90 | 90 | 96 | 107 | 122 |
| 96 | 90 | 90 | 94 | 103 | 118 | 136 |
| 92 | 90 | 91 | 96 | 106 | 124 | 143 |
| 95 | 89 | 85 | 108 | 125 | 149 | 171 |
| 98 | 90 | 83 | 108 | 122 | 145 | 168 |
| 96 | 88 | 82 | 107 | 118 | 143 | 166 |
| 93 | 86 | 81 | 104 | 115 | 139 | 164 |

The directional variances along 0°, 45°, 90°, and 135° directions can be calculated as: 0° variance=392.4592; 45° variance=42.3333; 90° variance=6.9592; 135° variance=318.6250. Using a Gaussian transfer function with the mean equal to the minimum of the calculated directional variances (which is 6.9592) and a configurable standard deviation std equal to 25% of the minimum (1.7398), the coefficient for each direction can be obtained from the Gaussian equation:

Gaussian=exp [−(α−μ)²/(2σ²)]

0° coefficient=exp [−(392.4592−6.9592)²/(2×1.73982)]=0

45° coefficient=exp [−(42.3333−6.9592)²/(2×1.73982)]=0

90° coefficient=exp [−(6.9592−6.9592)²/(2×1.73982)]=1

135° coefficient=exp [−(318.6250−6.9592)²/(2×1.73982)]=0

Each pixel is assigned with the coefficient corresponding to the maximum correlated direction, which is 90° in the above example. Accordingly, the coefficient matrix can be as:

$$\begin{matrix}0 & 0 & 0 & 1 & 0 & 0 & 0 \\ 0 & 0 & 0 & 1 & 0 & 0 & 0 \\ 0 & 0 & 0 & 1 & 0 & 0 & 0 \\ 0 & 0 & 0 & 1 & 0 & 0 & 0 \\ 0 & 0 & 0 & 1 & 0 & 0 & 0 \\ 0 & 0 & 0 & 1 & 0 & 0 & 0 \\ 0 & 0 & 0 & 1 & 0 & 0 & 0\end{matrix}$$

The normalized coefficient matrix is:

$$\begin{matrix}0 & 0 & 0 & 1 / 7 & 0 & 0 & 0 \\ 0 & 0 & 0 & 1 / 7 & 0 & 0 & 0 \\ 0 & 0 & 0 & 1 / 7 & 0 & 0 & 0 \\ 0 & 0 & 0 & 1 / 7 & 0 & 0 & 0 \\ 0 & 0 & 0 & 1 / 7 & 0 & 0 & 0 \\ 0 & 0 & 0 & 1 / 7 & 0 & 0 & 0 \\ 0 & 0 & 0 & 1 / 7 & 0 & 0 & 0\end{matrix}$$

The processed image data output from the FIR filtering module for the pixels in the detection window is: (96+103+106+125+122+128+115)/7=113.5714. In the above example, 25% of the minimum is selected as the standard deviation std. In fact, other values can be used, such as values less than 1.

As another example, a 3×3 detection window is employed with the image data as follows:

| | | |
|---|---|---|
| 242 | 124 | 116 |
| 59 | 227 | 5 |
| 155 | 194 | 209 |

The directional variances for 0°, 45°, 90°, & 135° are: 0° σ²=13404; 45° σ²=3171; 90° σ²=2766; and 135° σ²=273. Using a Gaussian with a mean equal to the minimum of these variances (273) and a standard deviation equal to 25% of this minimum (68.25), the coefficient for each direction becomes:

0° coefficient=exp(−(3404−273)²/(2*68.25²))=0

45° coefficient=exp(−(3171−273)²/(2*68.25²))=0

90° coefficient=exp(−(2766−273)²/(2*68.252))=0

135° coefficient=exp(−(273−273)²/(2*68.25 2))=1

Each pixel can then be assigned the coefficient corresponding to the largest correlated direction:

| | | |
|---|---|---|
| 1 | 0 | 0 |
| 0 | 1 | 0 |
| 0 | 0 | 1 |

The normalized coefficient matrix is:

$$\begin{matrix}1 / 3 & 0 & 0 \\ 0 & 1 / 3 & 0 \\ 0 & 0 & 1 / 3\end{matrix}$$

By applying the normalized coefficient matrix to the pixels in each detection window position, the image pixels in the detection window are filtered, for example through a standard convolution process. In the above example, the final, filtered result for the current pixel (e.g. the image aligned to 4D of the detection window in FIG. 5) is: 1/3*242+1/3*227+1/3*209=226. After processing the current pixel, the detection window is moved to a new position (e.g. the next image pixel in a row or a column), and the above processes are repeated.

The assembled FIR filter is then applied to both luminance and chrominance components of the input image. As an alternative feature, image sharpening can be performed at the same time, preferably along the least correlation direction (e.g. across the image edge). Specifically, the image sharpening can be performed with the same FIR kernel by applying negative coefficients in direction of the least correlation.

As an example wherein the detection window is 3x3 detection window is employed with the image data as follows:

| | | |
|---|---|---|
| 242 | 124 | 116 |
| 59 | 227 | 5 |
| 155 | 194 | 209 |

In an example, if the maximum directional variance is within 75% (or another predetermined programmable value) of the minimum directional variance, no sharpening is applied. This implies that there is no natural edge within the observation window. Otherwise, sharpening coefficients are calculated using a Gaussian with a mean equal to the maximum (13404) and a standard deviation that prevents overlap between correlated and non-correlated pixels. In other words, the two Gaussian transfer functions must not overlap. The following explains the standard deviation calculation:

μₛₕₐᵣₚ−3σₛₕₐᵣₚ>μₛₘₒₒₜₕ+3σₛₘₒₒₜₕ

σₛₕₐᵣₚ<(μₛₕₐₘₚ−μₛₘₒₒₜₕ−3σₛₘₒₒₜₕ)/3=(13404−273−3*68.25)/3=4308.75

The final, sharpening standard deviation is set equal to the minimum value between 0.75 times the maximum (10053) and the calculated limit (4308.75)=4308.75. Hence, the sharpening coefficients are:

0° coefficient=exp(−(13404−13404)²/(2*4308.75²))=1

45° coefficient=exp(−(3171−13404)²/(2*4308.75²))=0.06

90° coefficient=exp(−(2766−13404)²/(2*4308.75²))=0.05

135° coefficient=exp(−(273−13404)²/(2*4308.75²))=0.01

These coefficients are set negative to emphasize pixels across an edge. The sum of the positive and negative coefficients is preferably each equal to one. The amount sharpening may be controlled by fixing the positive and negative sums using the following procedure.

If sharpness is enabled, each positive coefficient is normalized by [p/(g+1)], and each negative coefficient is normalized by (n/g), wherein p is the sum of positive coefficients, g is the sharpness gain; and n is the sum of the negative coefficients. If sharpness is not enabled, each positive coefficient is normalized by p, and each negative coefficient is set to zero (0). Hence, the negative coefficients would be applied as follows:

| | | |
|---|---|---|
| −0.01 | −0.05 | −.06 |
| −1 | −1 | −1 |
| −0.06 | −0.05 | −0.01 |

It is further ruled that there can not be both a negative and positive coefficient for a single pixel. Positive coefficients take precedence. Hence, those negative coefficients that coincide with positive coefficients are forced to zero as follows:

| | | |
|---|---|---|
| −0.01 | −0.05 | −.06 |
| −1 | 0 | −1 |
| −0.06 | −0.05 | 0 |

The sum of the negative coefficients, n, is equal to 2.22. If the sharpening gain is set equal to 0.5, then the final coefficients become:

$$( \begin{matrix}1.5 / 3 & - 0.5 \times ( 0.5 / 2.22 ) & - 0.06 \times ( 0.5 / 2.22 ) \\ - 1 \times ( 0.5 / 2.22 ) & 1.5 / 3 & - 1 \times ( 0.5 / 2.22 ) \\ - 0.06 \times ( 0.5 / 2.22 ) & - 0.05 \times ( 0.5 / 2.22 ) & 1.5 / 3\end{matrix} )$$

Accordingly, the final, noise-reduced and sharpened result for the current pixel can be: 0.5×242−0.0113×124−0.0135×116−0.2252×59+0.5×227−0.2252×5−0.0135×155−0.0013×194+0.5×209=319.2753.

Examples disclosed herein can be implemented as a stand-alone software module stored in a computer-readable medium having computer-executable instructions for performing the filtering as disclosed herein. Alternatively, examples disclosed herein can be implemented in a hardware device, such an electronic device that can be either a stand-alone device or a device embedded in another electronic device or electronic board.

Referring to FIG. 8, electronic chip 98 comprises input pins Hₒ to Hₚ for receiving parameters used for configuring the operation of the FIR filter; image data pin(s) for receiving image data [D₀ . . . D₇], and control pins for data validity and clock. Processed data is output from pin Output. Alternatively, the electronic chip may provide a number of pins for receiving image data in parallel. The electronic chip can be composed of Filed-Programmable-Gate-Arrays, or ASIC. In either case, the electronic chip is capable of performing the FIR filtering.

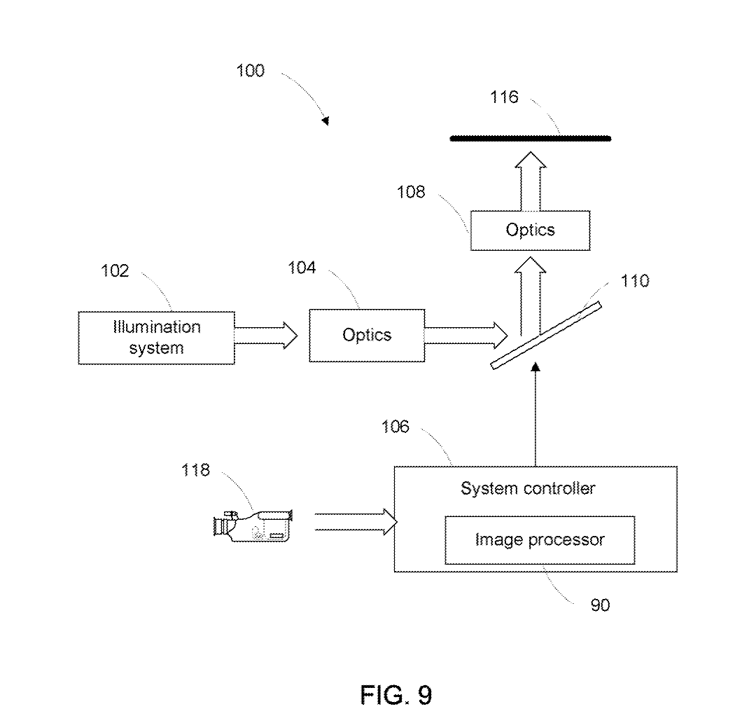

The FIR filtering as described above has many applications, one of which is in display systems. As an example, a display system employing the FIR filtering is demonstratively illustrated in FIG. 9. Referring to FIG. 9, display system 100 comprises illumination system 102 for providing illumination light for the system. The illumination light is collected and focused onto spatial light modulator 110 through optics 104. Spatial light modulator 110 that comprises an array of individually addressable pixels, such as micromirror devices, liquid-crystal-cells, and liquid-crystal-on-silicon cells modulates the illumination light under the control of system controller 106. The modulated light is collected and projected to screen 116 by optics 108. It is noted that instead of spatial light modulators, other type of image engines can also be used in the display system. For example, the display system may use light valves having emissive pixels, such as OLED cells, plasma cells or other suitable devices. In these display systems, the illumination system (102) may not be necessary.

The system controller is designated for controlling and synchronizing functional elements of the display system. One of the multiple functions of the system controller is receiving input images (or videos) from an image source 118; and processing the input image. Specifically, the system controller may have image processor 90 in which electronic chip as shown in FIG. 5 or other examples are implemented for performing the FIR filtering to the input images. The processed images are then delivered to spatial light modulator 110 for reproducing the input images.

It will be appreciated by those of skill in the art that a new and useful image correction method has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

I claim:

1. A method for processing an image having an array of image pixels, comprising:
defining a plurality of image pixel sub-arrays; and
processing an image pixel a sub-array, comprising:
calculating a plurality of directional variances for image pixels;
determining an array of coefficients of a filter based on the calculated directional variances; and
filtering the image pixel with the filter.

2. The method of claim 1, wherein the step of determining the array of coefficients further comprising:
determining the array of coefficients of the filter based on the maximum directional variance.

3. The method of claim 2, wherein the step of determining the array of coefficients further comprising:
determining the coefficients using a Gaussian transfer function.

4. The method of claim 3, wherein the step of determining the array of coefficients further comprising:
assigning the mean value of the Gaussian transfer function as the minimum of the calculated directional variance, and the variance of the Gaussian transfer function as a value proportional to the minimum variance.

5. The method of claim 1, wherein the step of calculating a plurality of directional variances further comprises:
calculating the directional variances along a multiplicity of predetermined directions.

6. The method of claim 1, wherein the filter is a finite impulse response filter.

7. The method of claim 6, wherein the directional variance is calculated from a luminance component of the image.

8. The method of claim 7, wherein the step of processing the image pixel further comprises:
detecting a block boundary of a block in the image; and
calculating the directional variances for image pixels on the same side of the detected block boundary.

9. The method of claim 8, further comprising:
calculating different directional variances for image pixels across the detected boundary.

10. The method of claim 9, wherein the step of detecting the block boundary comprises:
calculating an average gradient along each row of the image pixels in the sub-array;
calculating an average gradient along each column of the image pixels in the sub-array;
calculating a set of individual pixel gradients for the image pixels in the sub-array; and
determining the block boundary based upon the calculated gradients along the columns, rows, individual pixels, and a predetermined rule.

11. The method of claim 1, further comprising:
sharpening the image.

12. A method for improving quality of an image, comprising:
detecting an edge and an edge direction of an image feature; and
smoothing the image along the detected edge so as to reduce an artifact.

13. The method of claim 19, wherein the step of smoothing comprises:
smoothing the image using a finite impulse response filter.

14. The method of claim 13, further comprising:
detecting a block in the image by identifying a set of boundaries of the block;
collecting a set of luminance information of a plurality of pixels in the block; and
determining a set of coefficients of the finite impulse response filter based on the collected luminance information.

15. The method of claim 14, wherein the luminance information comprises an average vertical luminance, an average horizontal luminance for each row and column of the detection window, an individual vertical luminance and individual horizontal luminance for the pixels in each row, and column of the detection window.

16. The method of claim 16, wherein the edge and edge direction are identified based on a luminance variance of the pixels along a radial direction.

17. The method of claim 15, further comprising:
determining a strength of a transfer function of the FIR filter based on the collected luminance information with the information being weighted by the luminance variance in each radial direction.

18. The method of claim 17, wherein the weighting is accomplished through a Gaussian transfer function.

19. The method of claim 18, wherein the Gaussian transfer function has a mean equal to the minimum variance and a variance equal to a predetermined value.

20. The method of claim 19, wherein the luminance information and luminance variance are obtained through a luminance component of the image; and wherein the FIR filtering is applied to the luminance component and a chrominance component of the image.

21. A device for improving a quality of an image, comprising:
a block boundary identification module for identifying a compression artifact boundary in the image;
a directional correlation measurement module capable of identifying a direction of an edge present in an image feature; and
a filter coupled to the block boundary identification and directional correlation modules for filtering the input image, wherein the filter comprises a set of filtering coefficients that are determined by the identified image edge and image edge direction.

22. The device of claim 21, wherein the filter comprises a finite impulse response filter.

23. The device of claim 22, wherein the block boundary identification module is capable of identifying a boundary of a block resulted from the block compression in the image.

24. The device of claim 23, wherein the block boundary identification module has an input connected to a luminance component of the image; and an output connected to the directional correlation module; and another output connected to the filter.

25. The device of claim 24, wherein the directional correlation module has an output connected to the filter.

26. The device of claim 25, wherein the filter is connected to a chrominance component of the image.

27. The device of claim 26, wherein the device is a field-programmable-gate-array or an application-specific-integrated circuit.

28. The device of claim 21, wherein the directional correlation measurement module is capable of identifying the direction of the edge present in the image feature; while ignoring an edge detected by the block boundary identification module.

29. A computer-readable medium having computer executable instructions for performing a method for processing an image having an array of image pixels, wherein the method comprises:
defining a plurality of image pixel sub-arrays; and
processing an image pixel sub-array, comprising:
calculating a plurality of directional variances for image pixels;
determining an array of coefficients of a filter based on the calculated directional variances; and
filtering the image pixel with the filter.

30. A system for improving quality of an image, comprising:
detecting means for detecting an edge and an edge direction of an image feature; and
filtering means for filtering the image along the detected edge direction so as to improve a quality of the image.

31. The system of claim 30, wherein the filter means comprises a finite impulse response filter having a set of coefficients determined based on a set of directional variances of an edge of an image feature in the image.
